(19) United States
(12) Patent Application Publication
(10) Pub. No.: US 2024/0415140 A1
(43) Pub. Date: Dec. 19, 2024

(54) Double Network, Trans-free, and Fat-analogous Emulsion Gels for 3D/4D Printing and Preparation Thereof

(71) Applicant: Jiangnan University, Wuxi (CN)

(72) Inventors: Zong Meng, Wuxi (CN); Qinbo Jiang, Wuxi (CN)

(21) Appl. No.: 18/800,613

(22) Filed: Aug. 12, 2024

Related U.S. Application Data
(63) Continuation of application No. PCT/CN2022/097606, filed on Jun. 8, 2022.

(30) Foreign Application Priority Data
Feb. 16, 2022 (CN) 2022101512798

(51) Int. Cl. A23D 7/04; A23D 7/005; A23G 1/00; A23G 1/38; A23G 1/40; B33Y 10/00; B33Y 70/00

(52) U.S. Cl. CPC A23D 7/04; A23D 7/0053; A23G 1/0066; A23G 1/38; A23G 1/40; B33Y 70/00; B33Y 10/00

(57) ABSTRACT

The present disclosure discloses double network, trans-free, and fat-analogous emulsion gels for 3D/4D printing and preparation thereof, belonging to the technical field of healthy oil and food processing. A method of preparing the emulsion gels includes the following steps: (1) dissolving the hydrophilic colloid into hot water containing emulsifier nanoparticles with a mass concentration of 0.5-15% to obtain an aqueous solution; (2) dissolving oil-soluble small molecules in heated vegetable oil and uniformly mixing to obtain an oil solution, or mixing a variety of vegetable oil and heating to obtain a mixed oil; (3) mixing the aqueous solution in step (1) and the oil solution or mixed oil in step (2) in a volume ratio of 1:1-9:1, and homogenizing the mixture to obtain the emulsion gels. The emulsion gels can partially or completely replace traditional fats in food such as chocolate, ice cream and non-dairy cream, and are nutritious and healthy.

### TECHNICAL FIELD

The present disclosure relates to double network, trans-free, and fat-analogous emulsion gels for 3D/4D printing and preparation thereof, belonging to the technical field of healthy oil and food processing.

### BACKGROUND

3D printing methods in the field of food includes fused deposition, laser sintering and direct ink writing, among which the direct ink writing is widely used in 3D printing of edible materials because of its convenience and mild conditions. However, the direct ink writing requires the materials for printing to have certain rheological characteristics such that the materials can be discharged and molded smoothly during printing, so in food 3D printing, the materials that can be used for direct ink writing are mostly soft substances such as vegetable puree and gels, which leads to a low strength of the printing target, thereby greatly restricting the creativity of food 3D printing.

A high internal-phase emulsion can exhibit gel-like characteristics, which allow the high internal-phase emulsion to be well adapted to the direct ink writing and used for 3D printing. However, the emulsion often has no rigid structure inside, so the object printed using an emulsion does not have a high structural strength. Many high internal-phase oil-in-water emulsions are too high in oil content to meet consumers' demand for low-fat and healthy diets. Therefore, use of medium/high internal-phase water-in-oil emulsions in 3D printing can realize 3D printing by direct ink writing under the condition of low oil phase, and addition of a trans-free and low-saturated-fatty-acid oil-soluble network constructor and a healthy water-soluble network constructor respectively to the oil phase and the water phase can greatly increase the physical strength of the printing target, thereby overcoming the defects that the printed body is too soft to mold and the printing model has large limitations. Such double network, trans-free, and fat-analogous emulsion gels for 3D/4D printing can meet the consumers' demand for healthy food, and can realize more difficult and challenging printing target, which brings better experience to the consumers and allows the customized needs to be better realized by 3D printing.

### SUMMARY

### Technical Problems

At present, the substances prepared from emulsions by 3D printing do not have high structural strength, and the oil-in-water emulsions have a high oil content.

### Technical Solutions

In order to solve the above problems, the present disclosure provides solidifiable, trans-free and low-saturated-fat medium/high internal-phase water-in-oil fat-analogous emulsion gels for 3D/4D printing having characteristics of plastic fats. The present disclosure uses hydrophilic colloids, oil-soluble small molecule substances, vegetable oils and emulsifier nanoparticles as raw materials. By using the hydrophilic colloid as a network constructor of a water phase, the hydrophilic colloid is made into the aqueous solution. By using the oil-soluble small molecule substances or vegetable oil as the network constructor of an oil phase, the oil-soluble small molecules are dissolved in oil to prepare the oil solution, or one or more vegetable oils are made into a liquid-state mixed oil. The aqueous solution and the liquid-state mixed oil are mixed, the emulsifier nanoparticles are added, and the mixture is emulsified to prepare the double network, trans-free, low-saturated-fatty-acid, and fat-analogous emulsion gels. The prepared double network, trans-free, low-saturated-fatty-acid, and fat-analogous emulsion gels are used for 3D/4D printing, and the printed object is solidified under controlled temperature conditions, thereby increasing the structural strength of the printing target. The double network, trans-free, low-saturated-fatty-acid, and fat-analogous emulsion gels for 3D/4D printing of the present disclosure greatly reduces the oil content in a system, and uses a trans-free and low-saturated-fatty-acid healthy edible oil as the oil phase, and therefore, can be conveniently and quickly used in direct ink writing for 3D/4D printing. Due to their solidification performance, the double network, trans-free, low-saturated-fatty-acid, and fat-analogous emulsion gels can be used for printing more complicated targets in the field of food, so that the creativity of food producers and consumers can be fully displayed, thereby providing more space for the selection of materials for food 3D/4D printing.

A first objective of the present disclosure is to provide a method of preparing double network, trans-free, low-saturated-fatty-acid, and fat-analogous emulsion gels for 3D/4D printing, including the following steps:
(1) dissolving a hydrophilic colloid into hot water containing emulsifier nanoparticles to obtain an aqueous solution, where a mass concentration of the nanoparticles in the aqueous solution is 0.5-15%;
(2) preparation of oil solution or mixed oil
dissolving oil-soluble small molecules in heated vegetable oil, and uniformly mixing the mixture to obtain an oil solution;
or
mixing and heating a plurality of vegetable oils to obtain a mixed oil;
(3) mixing the aqueous solution in step (1) and the oil solution or the mixed oil in step (2) in a volume ratio of 1:1-9:1, and homogenizing and emulsifying the mixture to obtain the double network, trans-free, low-saturated-fatty-acid, and fat-analogous emulsion gels for 3D/4D printing.

In an embodiment of the present disclosure, the hydrophilic colloid in step (1) is one or more of hydroxypropyl methylcellulose, methyl cellulose, hydroxyethyl cellulose, xanthan gum, guar gum, carrageenan, flaxseed gum, pectin, gum arabic, locust bean gum, konjac glucomannan, agar, gellan gum, gelatin, whey protein, pea protein, soybean protein, mung bean protein, broad bean protein, peanut protein, chickpea protein, rice protein, oat protein and potato protein.

In an embodiment of the present disclosure, the emulsifier nanoparticles in step (1) are one or more of phytosterol particles, shellac particles, sucrose ester particles, monoglyceride particles and diglyceride particles.

In an embodiment of the present disclosure, the emulsifier nanoparticles in step (1) have a particle size of 100-3000 nm.

In an embodiment of the present disclosure, the hydrophilic colloid in step (1) has a mass concentration of 0.1-20% in the aqueous solution.

In an embodiment of the present disclosure, the hot water in step (1) is water with a temperature of 40-90° C.

In an embodiment of the present disclosure, the dissolving in step (1) is dissolving by stirring, and specifically dissolving by stirring at 100-2000 rpm for 0.5-10 min.

In an embodiment of the present disclosure, the vegetable oil in step (2) includes one or more of soybean oil, rapeseed oil, peanut oil, sunflower oil, tea seed soil, sesame oil, corn oil, wheat germ oil, olive oil, hemp oil, low erucic acid rapeseed oil, palm oil, palm olein, palm kernel oil, coconut oil, palm stearin, cocoa butter, shea butter stearin, sal fat, mango kernel oil, illipe butter and coconut oil stearin; and the vegetable oils for preparing the mixed oil need to contain at least one of palm oil, palm kernel oil, coconut oil, palm stearin, cocoa butter, shea butter stearin, sal fat, mango kernel oil, illipé butter, and coconut oil stearin, and have a mass percentage of more than 25% in the mixed oil.

In an embodiment of the present disclosure, the oil-soluble small molecules in step (2) are one or more of monoglyceride, diglyceride, mono and diglycerides of fatty acids, polyglycerol fatty acid ester, sodium stearoyl lactylate, sucrose fatty acid ester, lactic acid esters of mono and diglycerides, citric acid esters of mono and diglycerides, propylene ester of fatty acids, diacetyl tartaric acid esters of monoglycerides, diacetyl tartaric acid ester of diglycerides, acetylated monoglycerides, acetylated diglycerides, fatty alcohol, vegetable wax (carnauba wax, candelilla wax, rice bran wax, sugarcane wax and laurel wax) and animal wax (insect wax, beeswax, spermaceti and wool wax), and have a mass concentration of 0.5-15% in the oil solution.

In an embodiment of the present disclosure, the heating in step (2) is stirring at 40-150° C. for 0.5-10 min.

In an embodiment of the present disclosure, the mixing in step (3) is stirring and mixing at 40-90° C. for 0.5-10 min.

In an embodiment of the present disclosure, the homogenizing and emulsifying in step (3) is emulsifying at 5000-20000 rpm for 10-600 s.

A second objective of the present disclosure is double network, trans-free, low-saturated-fatty-acid, and fat-analogous emulsion gels for 3D/4D printing prepared by the method of the present disclosure.

A third objective of the present disclosure is use of the double network, trans-free, low-saturated-fatty-acid, and fat-analogous emulsion gels for 3D/4D printing of the present disclosure in the field of food.

In an embodiment of the present disclosure, the use includes use in the preparation of 3D/4D printed food and molecular gastronomy.

In an embodiment of the present disclosure, the use includes use in the preparation of chocolate.

A fourth objective of the present disclosure is to provide a method of customizing chocolate by 3D/4D printing, and the method is prepared from the double network, trans-free, low-saturated-fatty-acid, and fat-analogous emulsion gels for 3D/4D printing of the present disclosure by 3D printing.

The method includes the following steps:

adding the double network, trans-free, low-saturated-fatty-acid, and fat-analogous emulsion gels for 3D/4D printing prepared in the present disclosure to a 3D printing syringe while ensuring a system in the syringe to be homogeneous and non-dispersed;

adjusting an internal temperature of a printing chamber, choosing 3D printing head filling, and adjusting X, Y and Z axes of a 3D printer to zero by program setting;

designing a 3D model using digital model software, generating a plurality of corresponding 3D slices by slicing software to obtain a slice model, and calculating a path for each slice using programming G-code, so as to be finally inputted to the printer;

setting various parameters during 3D printing according to a material and a diameter of a needle used, specifically such as a printing layer thickness, a wall thickness, an infill density, a bottom layer and top layer thickness, a printing speed, etc.;

performing food 3D printing by the printer according to the imported slice model by means of extrusion to form a customized model with certain self-supporting properties.

In an embodiment of the present disclosure, the 3D printing syringe has a capacity of 50 mL, and may be a PVC plastic or aluminum syringe according to the temperature.

In an embodiment of the present disclosure, in the adjusting the internal temperature of the printing chamber, the temperature is set within a range of 0-60° C., further preferably 35-45° C.

In an embodiment of the present disclosure, a data modeling software used is Rhinoceros version 5.0, the 3D model imported from which is in a format obj, and the slicing software used is Cura version 15.02.1, where the file after slicing is in a format gcode.

In an embodiment of the present disclosure, the specific parameters of printing are as follows: the printing layer thickness is 0.5-1.2 mm, the wall thickness is 0.4-1.2 mm, the infill density is 10-60%, the bottom layer and top layer thickness is 0.5-1.2 mm, the printing speed is 40-120 mm/s, a printing temperature is 0-60° C., an initial layer thickness is 0.5-1.2 mm, an initial layer line width is 10-80%, a bottom layer removal is 0 mm, a moving speed is 20-200 mm/s, a bottom layer speed is 20-120 mm/s, an infill speed is 20-120 mm/s, a bottom layer and top layer speed is 20-100/s, a shell speed is 20-120 mm/s, and an inner wall speed is 10-80 mm/s.

A fifth object of the present disclosure is customized chocolate prepared by the method of the present disclosure.

A sixth objective of the present disclosure is to provide a biological porous material, prepared by freeze-drying after 3D printing of the double network, trans-free, low-saturated-fatty-acid, and fat-analogous emulsion gels for 3D/4D printing of the present disclosure.

### Beneficial Effects

(1) The double network, trans-free, low-saturated-fatty-acid, and fat-analogous emulsion gels for 3D/4D printing of the present disclosure refer to viscoelastic soft solids that can be used for direct ink writing in 3D printing before solidification. The structure of the emulsions is stabilized by hydrophobic Pickering particles, and the emulsions belong to high internal-phase emulsions and have similar physical characteristics to plastic fats. Thus, the emulsion gels can be used partially or completely instead of traditional fats in food production, and can also act as an intermediate template substance in the preparation of biological porous materials.
(2) The double network, trans-free, low-saturated-fatty-acid, and fat-analogous emulsion gels for 3D/4D printing of the present disclosure are prepared by the following steps: by using the hydrophilic colloid as the network constructor of the water phase, dissolving the water-soluble substance in water to prepare the aqueous solution; by using the oil-soluble small molecules or vegetable oil as the network constructor of the oil phase, the oil-soluble small molecules, or one or more vegetable oils are made into the liquid-state oil phase; adding the emulsifier nanoparticles into the mixed water and oil phases; and emulsifying the mixture to obtain the double network, trans-free, low-saturated-fatty-acid, and fat-analogous emulsion gels. The trans-free, low-saturated-fatty-acid, and fat-analogous emulsion gels can be structurally solidified under controlled temperature conditions after 3D printing, thereby increasing the structural strength of the printing target. The structural solidification is completed by the formation of the firm crystal network from the oil-soluble small molecules or vegetable oil in the oil phase under controlled temperatures. Such double network, trans-free, low-saturated-fatty-acid, and fat-analogous emulsion gels have viscoelastic properties like plastic fats before solidified, and have good thixotropy and plasticity. Compared with the use of the traditional high internal-phase oil-in-water emulsions in 3D printing, the double network, trans-free, low-saturated-fatty-acid, and fat-analogous emulsion gels for 3D/4D printing have good printability, and the crystal network in the oil phase can greatly increase the structural strength of the printing target, so that the customizability of the 3D printing is greatly improved, and thereby, the advantages of 3D printing can be greatly exerted in the field of food customization.
(3) The double network, trans-free, low-saturated-fatty-acid, and fat-analogous emulsion gels for 3D/4D printing of the present disclosure are soft solids that have properties of semisolids, and can exhibit the characteristics like traditional plastic fats. The emulsion gels can be used for 3D printing by direct ink writing, can produce crystal networks in the oil phase under controlled temperature conditions and allow the printed object to solidify, and can be used for 3D printing of more complicated food, thereby meeting the consumers' customized demands.
(4) The double network, trans-free, low-saturated-fatty-acid, and fat-analogous emulsion gels for 3D/4D printing of the present disclosure are mainly formed by low-content trans-free low saturated oil and healthy water-soluble biopolymers, which can make 3D printed food more healthy and safer, thereby meeting the consumers' demands for green and healthy products.
(5) The double network, trans-free, low-saturated-fatty-acid, and fat-analogous emulsion gels for 3D/4D printing of the present disclosure can be used as a template for preparing biological porous materials. The internal water phase can be removed by drying, leaving porous dry foam having a rigid structure, which can play an important role in cosmetics and medicine.
(6) The double network, trans-free, low-saturated-fatty-acid, and fat-analogous emulsion gels for 3D/4D printing of the present disclosure have a certain responsiveness to temperature, and can melt to some extent with the increase of the temperature, so corresponding food 4D printing can be designed accordingly.
(7) The double network, trans-free, low-saturated-fatty-acid, and fat-analogous emulsion gels for 3D/4D printing of the present disclosure contain no trans-fatty acids and low saturated fatty acids, can be used partially or completely instead of traditional plastic fats in food such as chocolate, ice cream and non-dairy cream, and are healthy and safe.

### BRIEF DESCRIPTION OF FIGURES

FIG. 1 shows a physical picture and microscope images of double network, trans-free, low-saturated-fatty-acid, and fat-analogous emulsion gels for 3D/4D printing prepared after mixing soybean oil and palm stearin in a mass ratio of 1:1 in Example 1, where (A) is a laser scanning confocal microscope image, (B) is an optical microscope image, (C) is a schematic diagram showing the emulsion microstructure, (D) is a scanning electron microscope image, and (E) is a partial enlarged image of (C);

FIG. 2A-2C shows rheological strain test results (FIG. 2A), time test results (FIG. 2B) and temperature test results (FIG. 2C) of the double network, trans-free, low-saturated-fatty-acid, and fat-analogous emulsion gels for 3D/4D printing prepared in Example 1;

FIG. 3A-3B shows Fourier transform infrared spectrum data of phytosterol nanoparticles, K-carrageenan and a freeze-dried sample of the double network, trans-free, low-saturated-fatty-acid, and fat-analogous emulsion gels for 3D/4D printing prepared after mixing soybean oil and palm stearin in a mass ratio of 1:1 in Example 1, wherein FIG. 3A shows the phytosterol nanoparticles and the κ-carrageenan, and FIG. 3B shows the emulsion gels prepared after mixing the soybean oil and the palm stearin in the mass ratio of 1:1 in Example 1;

FIG. 4A-4E shows polarizing microscope microscopic images of the double network, trans-free, low-saturated-fatty-acid, and fat-analogous emulsion gels for 3D/4D printing prepared in Example 1, wherein FIG. 4A-4E respectively represent the mass concentrations of the palm stearin in the oil phase of 0%, 25%, 50%, 75% and 100%;

FIG. 5 shows hardness test results of the double network, trans-free, low-saturated-fatty-acid, and fat-analogous emulsion gels for 3D/4D printing prepared in Example 1 after solidification;

FIG. 6A-6D shows physical pictures of products prepared in Comparative Example 1 (FIG. 6A) and Comparative Example 2 (FIG. 6B-6D), wherein FIG. 6A is Comparative Example 1, FIG. 6B is Comparative Example 2 in which the amount of phytosterol nanoparticles used is 0.5 g, FIG. 6C is Comparative Example 2 in which the amount of phytosterol nanoparticles used is 1 g, and FIG. 6D is Comparative Example 2 in which the amount of phytosterol nanoparticles used is 1.5 g;

FIG. 7A-7E shows extrusion test results of the double network, trans-free, low-saturated-fatty-acid, and fat-analogous emulsion gels for 3D/4D printing prepared in Example 2 when used in food 3D printing, wherein FIG. 7A-7E respectively represent the mass concentrations of the palm stearin of 0% (FIG. 7A), 25% (FIG. 7B), 50% (FIG. 7C), 75% (FIG. 7D) and 100% (FIG. 7E);

FIG. 8 shows physical pictures of turret models printed using the double network, trans-free, low-saturated-fatty-acid, and fat-analogous emulsion gels for 3D/4D printing prepared in Example 2;

FIG. 9 shows Hilbert curves printed using the double network, trans-free, low-saturated-fatty-acid, and fat-analogous emulsion gels for 3D/4D printing prepared in Example 3 and hardness test results thereof using a 500 g weight (a), and pictures of biological porous materials prepared by freeze-drying the emulsion gels and cryo-scanning electron microscope images thereof (b);

FIG. 10 shows chocolate made using molds prepared in Example 4 and microstructures thereof (a), and 4D printing effects of models obtained by 3D printing (b);

FIG. 11 shows a flower printed using the double network, trans-free, low-saturated-fatty-acid, and fat-analogous emulsion gels for 3D/4D printing prepared in Example 5;

FIG. 12 shows rheological frequency test results of the double network, trans-free, low-saturated-fatty-acid, and fat-analogous emulsion gels for 3D/4D printing prepared in Example 6; and

FIG. 13 shows an effect picture of the product prepared in Comparative Example 5 subjected to complicated structure 3D printing.

### DETAILED DESCRIPTION

Preferred examples of the present disclosure will be described below. It should be understood that the examples are intended to better explain the present disclosure and are not intended to limit the present disclosure. The parts mentioned in the examples are parts by mass.

### Test Methods:

1. The hardness of the solidified double network, trans-free, low-saturated-fatty-acid, and fat-analogous emulsion gels for 3D/4D printing was tested by a texture analyzer by means of single extrusion with a degree of strain of 30%.
2. The microstructure of the double network, trans-free, low-saturated-fatty-acid, and fat-analogous emulsion gels for 3D/4D printing was observed by a polarizing microscope, a laser scanning confocal microscope, a scanning electron microscope and a cryo-scanning electron microscope, with a magnification of 100-10000× and a test temperature of 25° C. or −80° C.
3. The rheological properties of the double network, trans-free, low-saturated-fatty-acid, and fat-analogous emulsion gels for 3D/4D printing were tested by a rotational rheometer. The fixture was an aluminum plate having a diameter of 40 mm. Strain scanning, temperature scanning and time scanning were carried out respectively. The strain scanning was carried out under the condition of 0.01-100%, and the temperature and the frequency were 45° C. and 1 Hz respectively. The temperature scanning was carried out under the condition of 20-50° C., and the strain and the frequency were 0.01% and 1 Hz respectively. The time scanning was carried out in three stages. The scanning time for each stage was 60 s. The strain of the first stage and the third stage was 0.01%, and the strain of the second stage was 100%. The temperature and the frequency were 45° C. and 1 Hz respectively. The frequency scanning was carried out under the conditions of a strain of 0.01% and a temperature of 45° C., and the frequency was increased from 0.01 Hz to 10 Hz.
4. The Fourier transform infrared spectrum of the double network, trans-free, low-saturated-fatty-acid, and fat-analogous emulsion gels for 3D/4D printing was tested by a Fourier transform infrared spectrometer. After being freeze-dried, the raw materials and the emulsions were scanned within a wave number of 4000-600 cm⁻¹.

### Example 1

A method of preparing double network, trans-free, low-saturated-fatty-acid, and fat-analogous emulsion gels for 3D/4D printing included the following steps:
(1) 0.3 g of κ-carrageenan was added to 95.7 g of 75° C. water containing 4 g of phytosterol nanoparticles (having a particle size of 1000 nm), and stirred at 400 rpm for 10 min such that the κ-carrageenan was dissolved, thereby obtaining an aqueous solution.
(2) Soybean oil and palm stearin (PKST) were mixed in a mass ratio of 1:0, 3:1, 1:1, 1:3 and 0:1 (the mass concentrations of the palm stearin were 0%, 25%, 50%, 75% and 100%) at 70° C., and stirred at 400 rpm for 10 min until they were thoroughly mixed, thereby obtaining a mixed oil.
(3) The aqueous solution in step (1) and the mixed oil in (2) were stirred in a volume ratio of 3:1 at 400 rpm at 70° C. for 10 min until they were thoroughly mixed, and then the mixture was homogenized and emulsified at a speed of 16000 rpm for 4 min, thereby obtaining the double network, trans-free, low-saturated-fatty-acid, and fat-analogous emulsion gels for 3D/4D printing.

The obtained fat-analogous emulsion gels were tested. The test results are as follows:

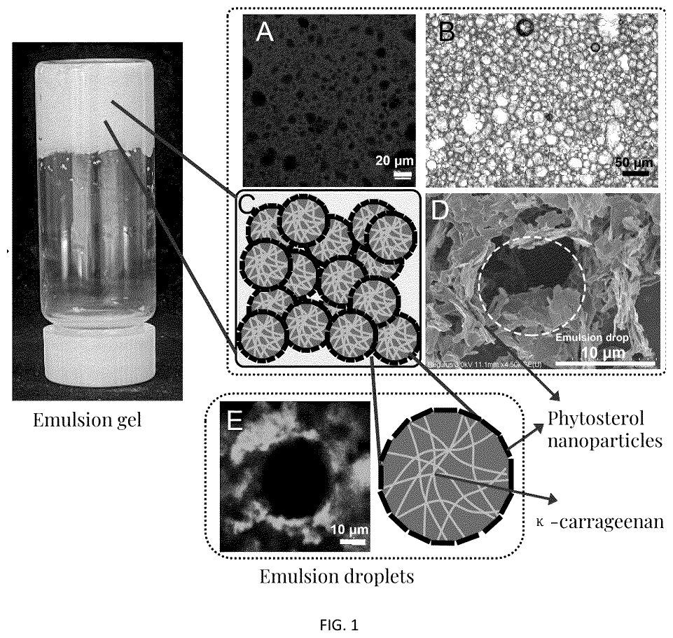

FIG. 1 shows a physical picture and microstructure images of the double network, trans-free, low-saturated-fatty-acid, and fat-analogous emulsion gels for 3D/4D printing prepared after mixing the soybean oil and the palm stearin in a mass ratio of 1:1. As can be seen from FIG. 1, the double network, trans-free, low-saturated-fatty-acid, and fat-analogous emulsion gels exhibit properties of a semisolid. Emulsion drops are stabilized by the phytosterol nanoparticles. The emulsion drops pile up together to form a gel network, and the κ-carrageenan existing in the water phase of the emulsion gel is used as a water phase structure enhancer to stabilize the water in the emulsion drops.

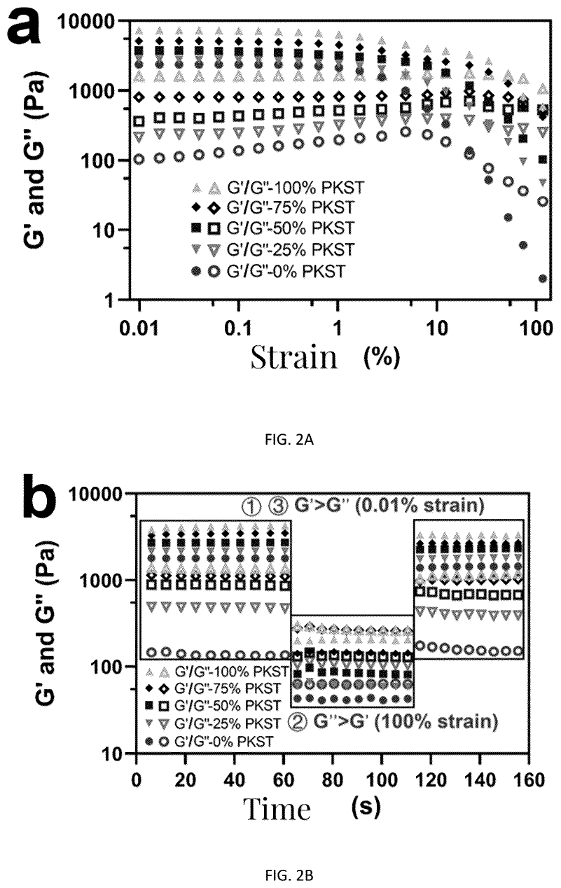

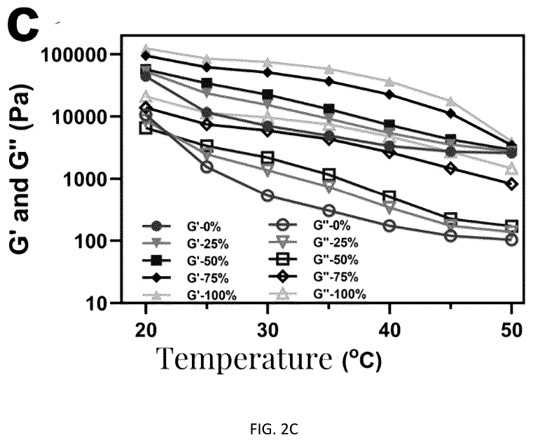

FIG. 2A-2C shows rheological test results of the emulsion gels. As can be seen from FIG. 2A-2C, G′ of the sample is greater than G″ in the linear viscoelastic region, and G″ will surpass G′ as the shear strain increases, which means that the emulsion gels have thixotropy; in the time scanning test, the emulsion gels can still recover the modulus to a great extent after strong shear failure; in the temperature scanning, it can be found that as the temperature decreases, the modulus of the emulsion gels increases rapidly, which is closely related to the role of the mixed oil (structure enhancer) in the water phase and the oil phase during the cooling process.

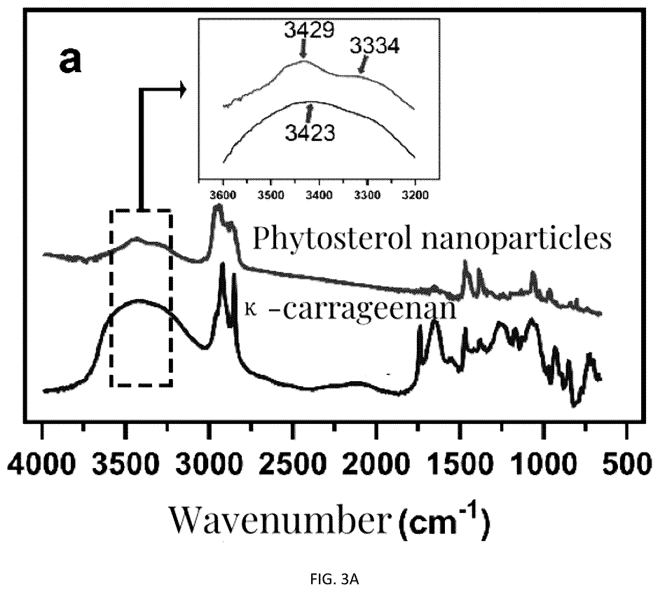

FIG. 3A-3B shows Fourier transform infrared spectra of the phytosterol nanoparticles, the κ-carrageenan and the dried emulsion gels (prepared from the soybean oil and the palm stearin in a mass ratio of 1:1). As can be seen from FIG. 3A-3B, the hydroxyl absorption peak of the dried emulsion gels near 3400 cm⁻¹ has a red shift to some degree as compared with the absorption peaks corresponding to the phytosterol nanoparticles and the κ-carrageenan, which means that the κ-carrageenan in the water phase of the emulsion gels enhances the structure of the water phase by means of hydrogen bonds, and there is hydrogen bonding at the interface of the emulsion drops of the phytosterol nanoparticles.

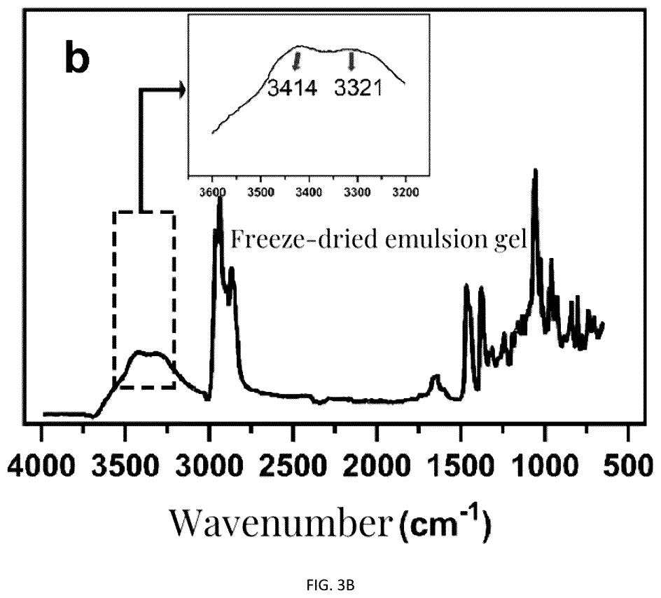

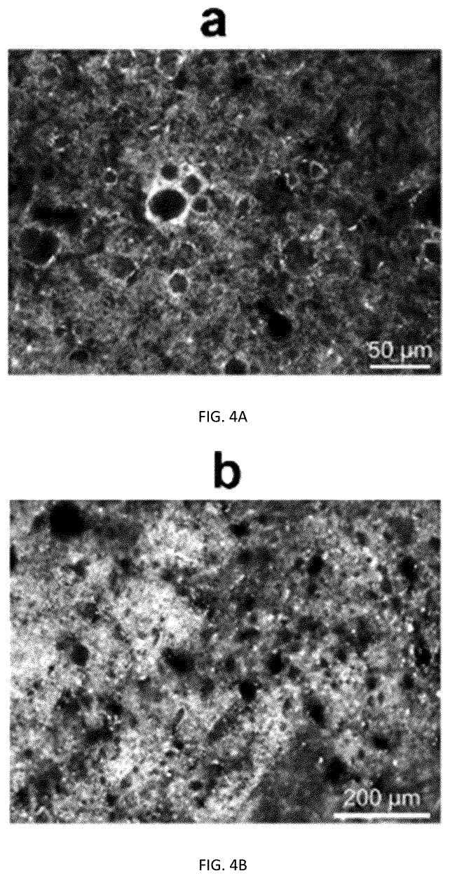

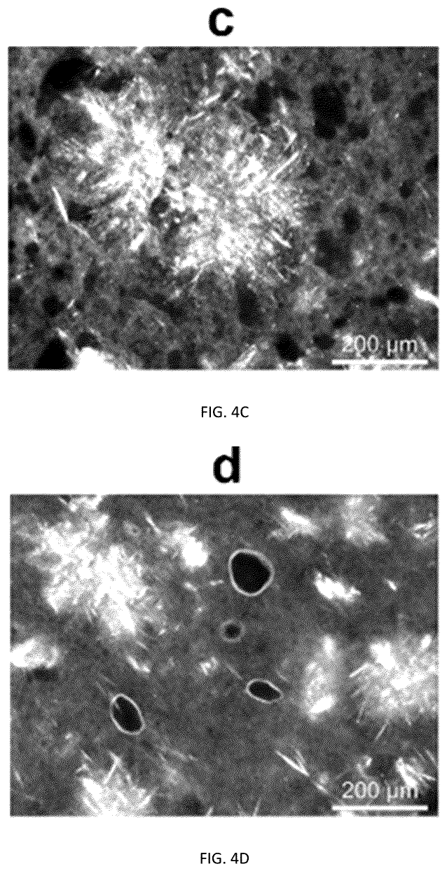

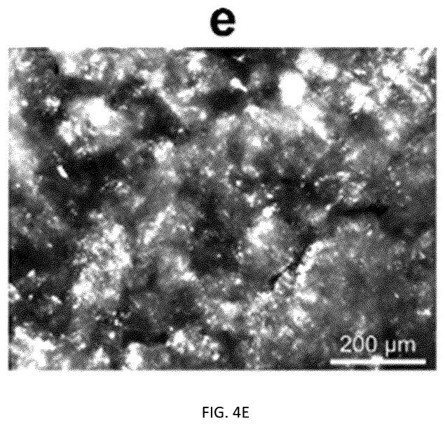

FIG. 4A-4E shows polarizing microscope images of the emulsion gels. As can be seen from FIG. 4A-4E, the visible light spots in the images are palm stearin in the emulsion gels, which indicates that the oil phase in the emulsion gels is enhanced by the crystal network formed by the palm stearin.

Table 1 and FIG. 5 show hardness data of the solidified emulsion gels. As can be seen from Table 1, as the concentration of the palm stearin increases, the hardness of the solidified emulsion gels increases exponentially.

TABLE 1
Hardness of solidified fat-analogous emulsion gels

| Mass ratio of soybean | Hardness |
|---|---|
| oil to palm stearin | (g) |
| 1:0 | 42.57 |
| 3:1 | 453.67 |
| 1:1 | 2211.57 |
| 1:3 | 6293 |
| 0:1 | 12717 |

The contents of trans-fats and saturated fats in the double network, trans-free, low-saturated-fatty-acid, and fat-analogous emulsion gels for 3D/4D printing of Example 1 were tested by a gas chromatograph. The temperature program was as follows: a temperature of 130° C. was kept for 0-3 min, raised to 200° C. at a speed of 5° C./min, then raised to 220° C. at 2° C./min, and kept for 3 min. The split ratio was 20, and the flow rate of the chromatographic column was 1.8 mL/min. The contents of the trans fats and the saturated fats in the double network, trans-free, low-saturated-fatty-acid, and fat-analogous emulsion gels for 3D/4D printing are shown in Table 2.

TABLE 2
Contents of trans-fatty acids and saturated fatty acids
in double network, trans-free, and fat-analogous emulsion
gels for 3D/4D printing (mass percentage)

| Percentage of palm stearin | Trans-fatty | Saturated fatty |
|---|---|---|
| in the oil phase (wt %) | acids (%) | acids (%) |
| 0 | 0 | 4.33 |
| 25 | 0 | 6.38 |
| 50 | 0 | 11.55 |
| 75 | 0 | 15.14 |
| 100 | 0 | 18.78 |
| Commercially available butter | 0.20 | 48.15 |

As can be seen from Table 2, compared with the commercially available butter, the double network, trans-free, low-saturated-fatty-acid, and fat-analogous emulsion gels for 3D/4D printing contain no trans-fatty acids, and have a much lower content of saturated fatty acids than that (48.15%) in the commercially available butter, thereby meeting the consumers' demands for healthy diets.

### Comparative Example 1

The volume ratio of the aqueous solution of step (1) and the mixed oil of step (2) in step (3) of Example 1 was adjusted to 1:3, and the rest was the same as in Example 1 (the mass ratio of the soybean oil to the palm stearin was 1:1), thereby obtaining the product.

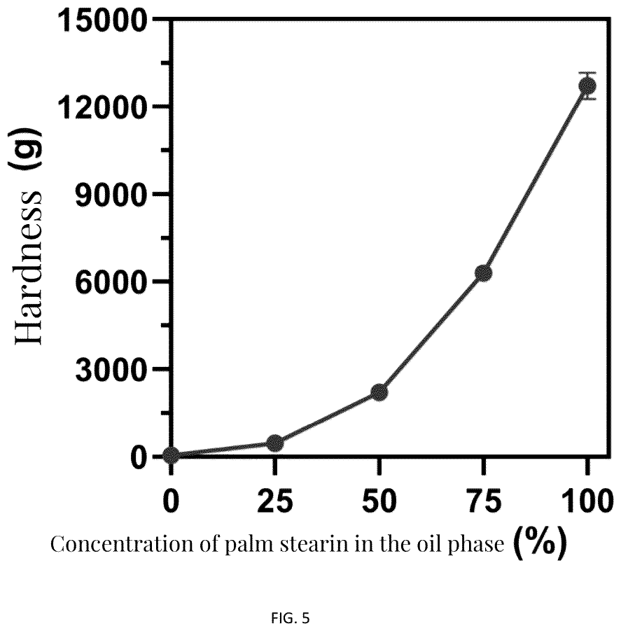

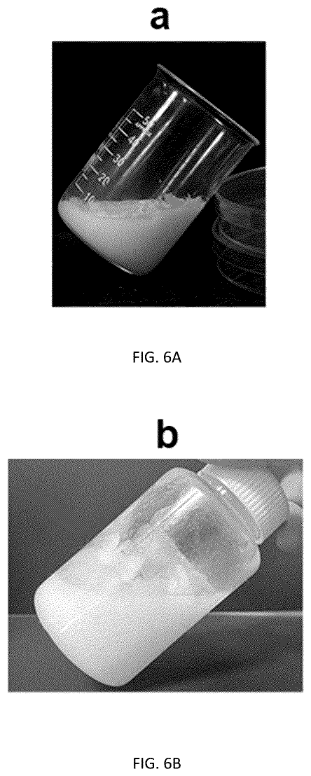

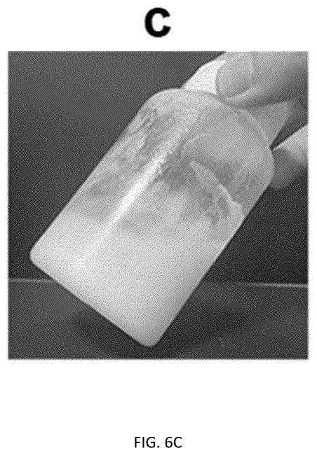

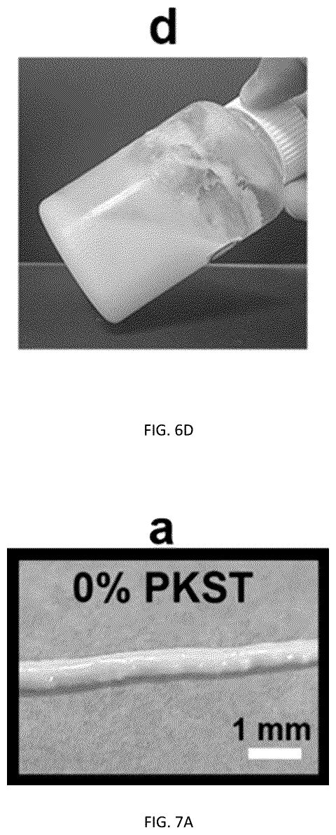

It is found through the tests that as shown in a in FIG. 6A-6D, the product has strong fluidity, and does not have good moldability. Therefore, the product cannot become a plastic semisolid, and cannot be used for 3D printing.

### Comparative Example 2

The amount of the phytosterol nanoparticles used in Example 1 was adjusted to 0.5 g, 1 g and 1.5 g, and the corresponding mass of water was 99.2 g, 98.7 g and 98.2 g. The rest was the same as in Example 1 (the mass ratio of the soybean oil to the palm stearin was 1:1), thereby obtaining the products.

The obtained products are shown in FIG. 6B-6D. Since the concentrations of the phytosterol nanoparticles are too low, the formed products have strong fluidity and cannot form viscoelastic bodies having plasticity. Therefore, the emulsion products prepared using low concentrations of phytosterol nanoparticles do not have rheological properties for 3D printing.

### Comparative Example 3

The phytosterol nanoparticles in Example 1 were adjusted to octenyl succinic anhydride modified quinoa starch nanoparticles (900 nm), and the rest was the same as in Example 1 (the mass ratio of the soybean oil to the palm stearin was 1:1), thereby obtaining the product.

The obtained product is an oil-in-water emulsion in which the oil phase is used as the internal phase. The crystal network in the oil phase cannot solidify the emulsion system, so it is impossible to obtain a solidified product.

### Comparative Example 4

The phytosterol nanoparticles in Example 1 were adjusted to whey protein nanoparticles (1000 nm), and the rest was the same as in Example 1 (the mass ratio of the soybean oil to the palm stearin was 1:1), thereby obtaining the product.

The obtained product is an oil-in-water emulsion in which the oil phase is used as the internal phase. The crystal network in the oil phase cannot solidify the emulsion system, so it is impossible to obtain a solidified product.

### Example 2

Use of the double network, trans-free, low-saturated-fatty-acid, and fat-analogous emulsion gels prepared in Example 1 in food 3D printing included the following steps:
(1) The double network, trans-free, low-saturated-fatty-acid, and fat-analogous emulsion gels prepared in Example 1 were kept at a temperature of 40° C., and transferred into a storage tank of a food 3D printer, and the temperature of the storage tank was set to 45° C.
(2) The double network, trans-free, low-saturated-fatty-acid, and fat-analogous emulsion gels for 3D/4D printing were added to a 3D printing syringe while ensuring the system in the syringe to be homogeneous and non-dispersed. An internal temperature of a printing chamber was adjusted to 45° C., 3D printing head filling was chosen, and X, Y and Z axes of the 3D printer were adjusted to zero by program setting. A needle having a diameter of 0.85 mm was selected. Various parameters during 3D printing were set, specifically a printing layer thickness (0.85 mm), a wall thickness (0.85 mm), an infill density (50%), a bottom layer and top layer thickness (0.85 mm) and a printing speed (40 mm/s).
(3) Turret models were printed using the printer.

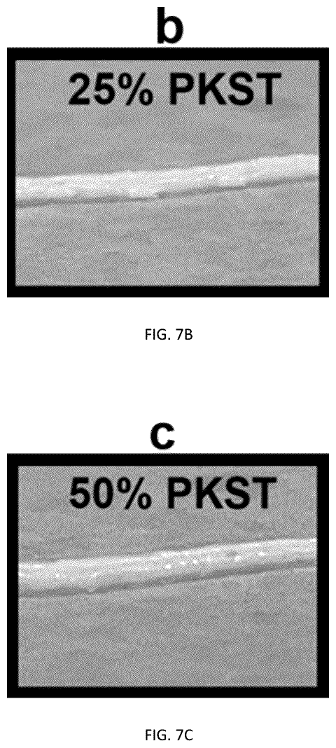

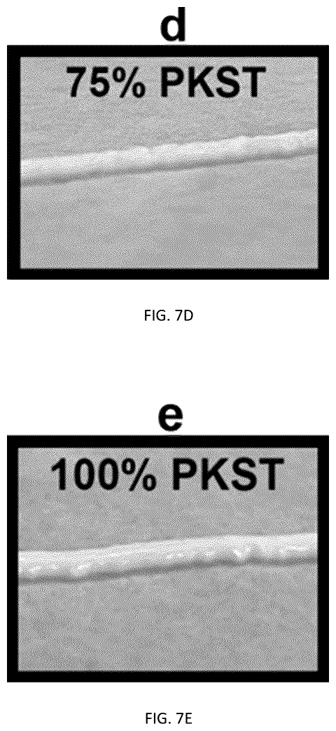

FIG. 7A-7E shows extrusion test results of the emulsion gels by using the 3D printer. As can be seen from FIG. 7A-7E, the amount of the palm stearin added does not affect the 3D printing extrusion of the emulsion gels, and all samples have good extrudability.

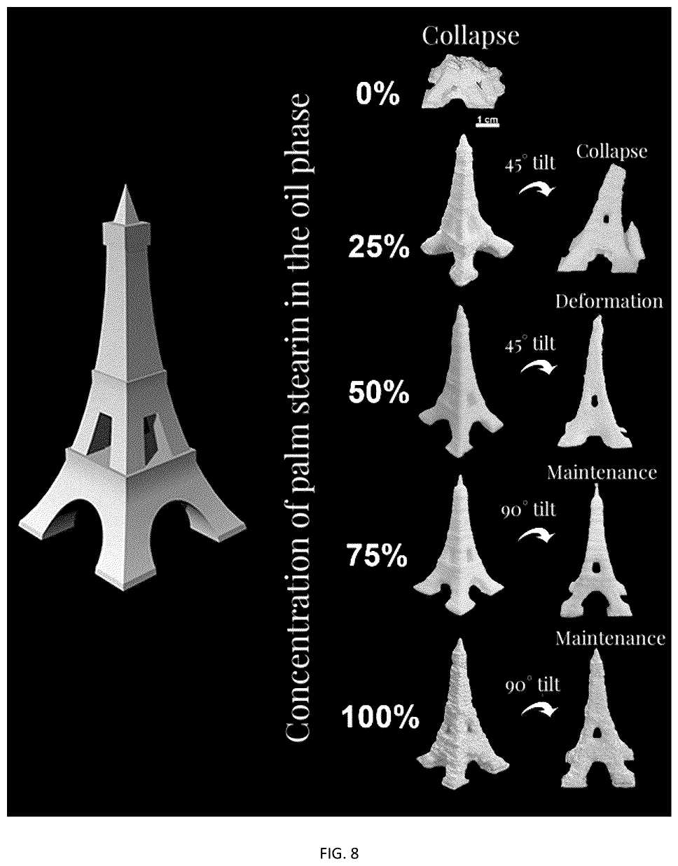

FIG. 8 shows the turret models 3D-printed using the emulsion gel products. As can be seen from FIG. 8, in the emulsion gel containing palm stearin, when the concentration of the palm stearin in the oil phase is 25%, the model can be printed completely, but it will collapse once it tilts. When the concentration of the palm stearin in the oil phase is greater than 50%, the model will not collapse basically when it tilts, which indicates that the palm stearin has significant solidification effect on the system and is helpful in printing a complicated model. When the concentration of the palm stearin in the oil phase is 0, the product has good printability and extrudability, but does not have good structural strength after being printed, which leads to the collapse of the model during the printing process.

### Example 3 Use as Template in Preparation of Rigid Biological Porous Material

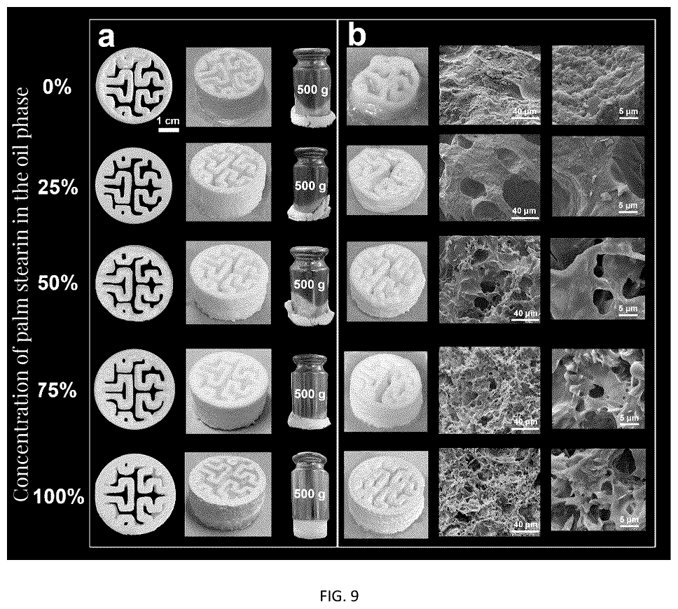

Hilbert curves were printed from the palm-stearin-containing double network, trans-free, low-saturated-fatty-acid, and fat-analogous emulsion gels for 3D/4D printing prepared in Example 1 by using a food 3D printer according to the method of Example 2. The printed objects were cooled at room temperature and solidified, and then tested for their hardness using a weight. The test results are shown in FIG. 9.

As can be seen from FIG. 9, when the content of the palm stearin in the oil phase reaches 100%, the printed object can support a 500 g weight, which indicates that the solidified printed object has strong rigidity (a in FIG. 9); and when the content of the palm stearin in the oil phase reaches 0, the product cannot support the 500 g weight.

The printed object was quickly frozen in a −80° C. refrigerator for 1 h and then freeze-dried for 24 h to obtain a rigid biological porous material with water removed. For the printed object containing the palm stearin, its appearance did not change after freeze-drying. The cryo-scanning electron microscope images of the biological porous material are shown in b in FIG. 9. As the concentration of the palm stearin increases, the retention of the pore structure inside the biological porous material increases gradually. When the content of the palm stearin in the oil phase reaches 0, the dried printed object of the product collapses from the outside, and the pore structure inside also disappears. This is because the oil phase in the emulsion gel does not contain a network constructor (palm stearin) and cannot function to solidify the product.

### Example 4

The double network, trans-free, low-saturated-fatty-acid, and fat-analogous emulsion gels for 3D/4D printing prepared by using 100% palm stearin as the oil phase in Example 1 were used instead of 30% of cocoa butter to prepare chocolate, specifically including the followings:

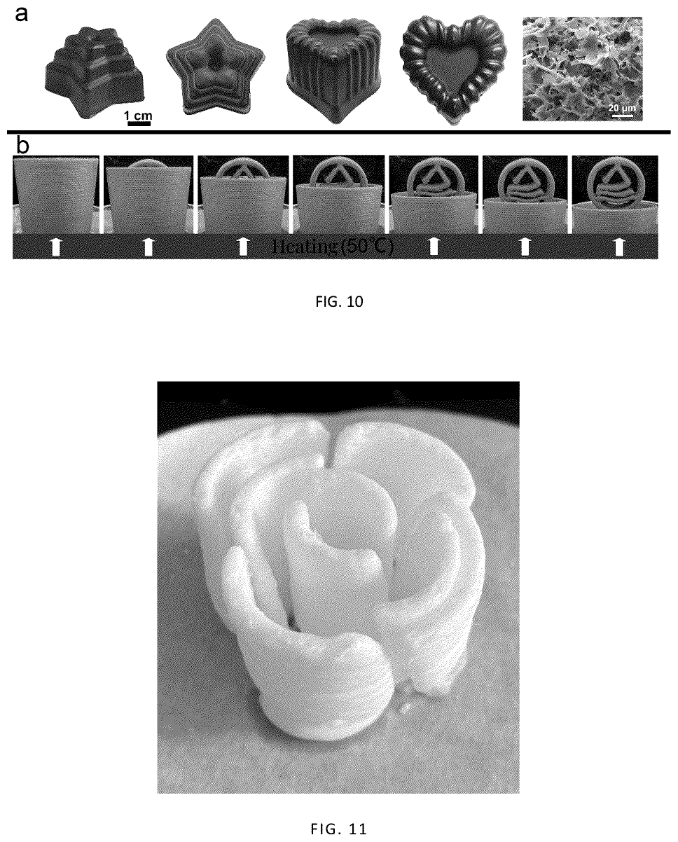

60 parts of emulsion gel, 15 parts of cocoa powder and 25 parts of powdered sugar were heated to 65° C. and thoroughly mixed, and then used to make chocolate by using molds. The appearances are shown in a in FIG. 10. As can be seen from the figure, the emulsion gels can be used for preparing chocolate with no obvious defects in appearance when partially replacing cocoa butter, and the oil content in the chocolate is significantly reduced.

75 parts of emulsion gel, 10 parts of cocoa powder and 15 parts of powdered sugar were heated to 65° C. and thoroughly mixed. The mixed chocolate paste was added to a 40° C. storage tank of a food 3D printer and allowed to stand for 1 h. Two separate objects were printed by using the food 3D printer. After the printing was completed, the printed objects were allowed to stabilize at room temperature for half an hour, and then placed on a 50° C. heating plate so as to realize the effect of food 4D printing. The physical objects are shown in b in FIG. 10.

### Example 5

Step (2) in Example 1 was adjusted as follows:

Rice bran wax was added to soybean oil, and stirred at 400 rpm at 80° C. for 10 min to obtain an oil solution. A mass fraction of the rice bran wax in the oil solution was 15%.

Step (1) and step (3) were the same as in Example 1. The double network, trans-free, low-saturated-fatty-acid, and fat-analogous emulsion gels for 3D/4D printing were obtained.

Then, 3D printing was carried out, specifically including the followings:

The obtained double network, trans-free, low-saturated-fatty-acid, and fat-analogous emulsion gels for 3D/4D printing were kept at 70° C., and transferred into a storage tank of a food 3D printer, and the temperature of the storage tank was set to 70° C.

The double network, trans-free, low-saturated-fatty-acid, and fat-analogous emulsion gels for 3D/4D printing were added to a 3D printing syringe while ensuring the system in the syringe to be homogeneous and non-dispersed. An internal temperature of a printing chamber was adjusted to 70° C., 3D printing head filling was chosen, and X, Y and Z axes of the 3D printer were adjusted to zero by program setting. A needle having a diameter of 0.85 mm was selected. Various parameters during 3D printing were set, specifically a printing layer thickness (0.85 mm), a wall thickness (0.85 mm), an infill density (50%), a bottom layer and top layer thickness (0.85 mm) and a printing speed (40 mm/s).

A printing test of a flower model was carried out by the printer.

The 3D-printed and solidified flower is shown in FIG. 11. As can be seen, the oil-soluble small molecule rice bran wax dissolved in soybean oil also has the effects of solidifying the system and strengthening the 3D printing target.

### Example 6

Step (1) in Example 1 was adjusted as follows:

0.3 g of κ-carrageenan was added to 98.7 g of 75° C. water containing 1 g of carboxylated shellac nanoparticles (having a particle size of 100 nm), and stirred at 400 rpm for 10 min such that the κ-carrageenan was dissolved, thereby obtaining an aqueous solution.

The rest was the same as in Example 1. The fat-analogous emulsion gels were obtained.

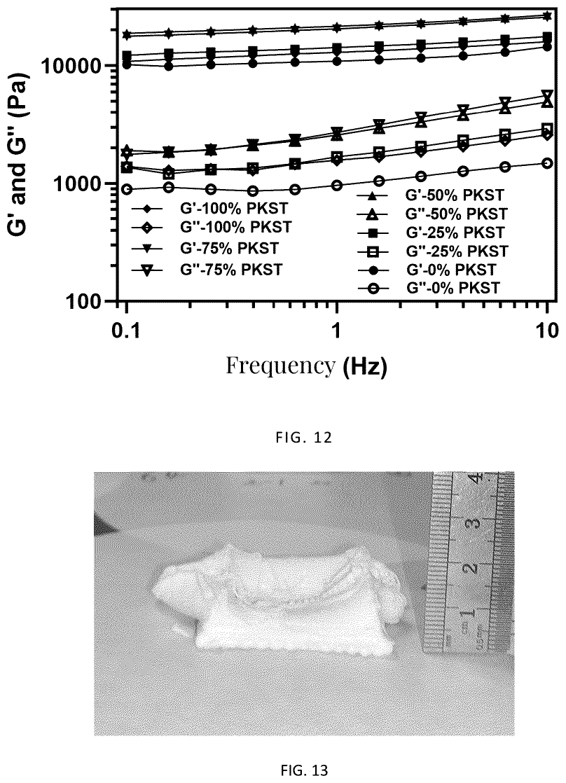

The obtained fat-analogous emulsion gels were subjected to rheological testing. The test results are shown in FIG. 12:

As can be seen from FIG. 12, in the rheological testing with small oscillation frequency, the obtained fat-analogous emulsion gels all exhibit viscoelastic properties of semisolids (G′>G″). Therefore, the fat-analogous emulsion gels prepared using the shellac nanoparticles are also capable of 3D/4D printing and have high plasticity and printability.

### Comparative Example 5

A method of preparing an emulsion gel type fat substitute included the following steps:
(1) 10 parts of ethyl cellulose and 2 parts of glycerol monostearate were dissolved in 88 parts of 150° C. soybean oil, stirred for 10 min, and placed in a 70° C. water bath, thereby obtaining an oil solution.
(2) 10 parts of gelatin was dissolved in 90 parts of 70° C. hot water, and stirred for 10 min, thereby obtaining an aqueous solution.
(3) The oil solution in step (1) and the aqueous solution in step (2) were uniformly mixed in a mass ratio of 5:5, and the mixed solution was emulsified by a high-speed homogenizer at a speed of 10000 rpm for 2 min, thereby obtaining an emulsion. The obtained emulsion was stirred at room temperature at a low speed of 400 rpm until the system gelatinizes, thereby obtaining the emulsion gel type fat substitute.

Then, 3D printing was carried out according to the method in Example 2. The result is shown in FIG. 13.

As can be seen from FIG. 13, the emulsion gel type fat substitute prepared in Comparative Example 5 cannot produce a rigid network structure due to its low structural strength. Therefore, the 3D printed object has low structural strength and is prone to collapse during the printing process. As a result, the emulsion gel type fat substitute cannot be used for printing a complicated model, and cannot be used for 4D printing.

When the mass ratio of the oil solution in step (1) and the aqueous solution in step (2) is 2:8, 4:6, 6:4 and 8:2, the printing performance is not as good as the case where the mass ratio is 5:5. As a result, the emulsion gel type fat substitute has weak printing performance, cannot be used for 3D printing of a complicated model, and cannot be used for 4D printing at all.

Although the present disclosure has been disclosed as above by way of the preferred examples, they are not intended to limit the present disclosure. Any person skilled in the art can make various changes and modifications without departing from the spirit and scope of the present disclosure. Therefore, the protection scope of the present disclosure should be as defined in the claims.

What is claimed is:

1. A method of preparing double network, trans-free, low-saturated-fatty-acid, and fat-analogous emulsion gels for 3D/4D printing, comprising the following steps:
(1) dissolving a hydrophilic colloid into hot water containing emulsifier nanoparticles to obtain an aqueous solution, wherein a mass concentration of the emulsifier nanoparticles in the aqueous solution is 0.5-15%;
(2) preparing oil solution or mixed oil:
dissolving oil-soluble small molecules in heated vegetable oil, and uniformly mixing the mixture to obtain an oil solution;
or
mixing and heating a plurality of vegetable oils to obtain the mixed oil; and
(3) mixing the aqueous solution in step (1) and the oil solution or the mixed oil in step (2) in a volume ratio of 1:1-9:1, and homogenizing and emulsifying the mixture to obtain the double network, trans-free, low-saturated-fatty-acid, and fat-analogous emulsion gels for 3D/4D printing.

2. The method according to claim 1, wherein the vegetable oil in step (2) comprises one or more of soybean oil, rapeseed oil, peanut oil, sunflower oil, tea seed soil, sesame oil, corn oil, wheat germ oil, olive oil, hemp oil, low erucic acid rapeseed oil, palm oil, palm olein, palm kernel oil, coconut oil, palm stearin, cocoa butter, shea butter stearin, sal fat, mango kernel oil, illipe butter and coconut oil stearin; and the vegetable oils for preparing the mixed oil need to contain at least one of palm oil, palm kernel oil, coconut oil, palm stearin, cocoa butter, shea butter stearin, sal fat, mango kernel oil, illipe butter, and coconut oil stearin, and the vegetable oil in step (2) has a mass percentage of more than 25% in the mixed oil.

3. The method according to claim 1, wherein the emulsifier nanoparticles in step (1) are one or more of phytosterol nanoparticles, shellac nanoparticles, sucrose ester nanoparticles, monoglyceride nanoparticles and diglyceride nanoparticles.

4. The method according to claim 1, wherein the oil-soluble small molecules in step (2) are one or more of monoglyceride, diglyceride, mono and diglycerides of fatty acids, polyglycerol fatty acid ester, sodium stearoyl lactylate, sucrose fatty acid ester, lactic acid esters of mono and diglycerides, citric acid esters of mono and diglycerides, propylene ester of fatty acids, diacetyl tartaric acid esters of monoglycerides, diacetyl tartaric acid ester of diglycerides, acetylated monoglycerides, acetylated diglycerides, fatty alcohol, vegetable wax and animal wax, and the oil-soluble small molecules have a mass concentration of 0.5-15% in the oil solution.

5. The method according to claim 1, wherein the hydrophilic colloid in step (1) is one or more of hydroxypropyl methylcellulose, methyl cellulose, hydroxyethyl cellulose, xanthan gum, guar gum, carrageenan, flaxseed gum, pectin, gum arabic, locust bean gum, konjac glucomannan, agar, gellan gum, gelatin, whey protein, pea protein, soybean protein, mung bean protein, broad bean protein, peanut protein, chickpea protein, rice protein, oat protein and potato protein.

6. The method according to claim 1, wherein the emulsifier nanoparticles in step (1) have a particle size of 100-3000 nm.

7. The method according to claim 1, wherein the hydrophilic colloid in step (1) has a mass concentration of 0.1-20% in the aqueous solution.

8. The method according to claim 1, wherein the dissolving in step (1) is dissolving by stirring, and specifically dissolving by stirring at 100-2000 rpm for 0.5-10 minutes.

9. The method according to claim 1, wherein the hot water in step (1) is water with a temperature of 40-90° C.

10. The method according to claim 1, wherein the heating in step (2) is stirring at 40-150° C. for 0.5-10 minutes.

11. The method according to claim 1, wherein the mixing in step (3) is stirring and mixing at 40-90° C. for 0.5-10 minutes.

12. The method according to claim 1, wherein the homogenizing and emulsifying in step (3) is emulsifying at 5000-20000 rpm for 10-600 seconds.

13. Double network, trans-free, low-saturated-fatty-acid, and fat-analogous emulsion gels for 3D/4D printing prepared by the method according to claim 1.

14. A method of customizing chocolate by 3D/4D printing, wherein the chocolate is prepared by 3D printing with the double network, trans-free, low-saturated-fatty-acid, and fat-analogous emulsion gels for 3D/4D printing according to claim 13.

15. The method according to claim 14, wherein the method comprises the following steps:
adding the double network, trans-free, low-saturated-fatty-acid, and fat-analogous emulsion gels for 3D/4D printing to a 3D printing syringe while ensuring a system in the syringe to be homogeneous and non-dispersed;
adjusting an internal temperature of a printing chamber, choosing 3D printing head filling, and adjusting X, Y and Z axes of a 3D printer to zero by program setting;
designing a 3D model using digital model software, generating a plurality of corresponding 3D slices by slicing software to obtain a slice model, and calculating a path for each slice using programming G-code, so as to be inputted to the printer;
setting various parameters during 3D printing according to a material and a diameter of a needle used, including a printing layer thickness, a wall thickness, an infill density, a bottom layer and top layer thickness, a printing speed;
performing food 3D printing by the printer according to the imported slice model by extrusion to form a customized model with certain self-supporting properties.

16. The method according to claim 15, wherein in the adjusting the internal temperature of the printing chamber, the temperature is set within a range of 0-60° C.

17. The method according to claim 15, wherein the parameters of printing are as follows: the printing layer thickness is 0.5-1.2 mm, the wall thickness is 0.4-1.2 mm, the infill density is 10-60%, the bottom layer and top layer thickness is 0.5-1.2 mm, the printing speed is 40-120 mm/s, a printing temperature is 0-60° C., an initial layer thickness is 0.5-1.2 mm, an initial layer line width is 10-80%, a bottom layer removal is 0 mm, a moving speed is 20-200 mm/s, a bottom layer speed is 20-120 mm/s, an infill speed is 20-120 mm/s, a bottom layer and top layer speed is 20-100/s, a shell speed is 20-120 mm/s, and an inner wall speed is 10-80 mm/s.
